(19) United States
(12) Patent Application Publication
(10) Pub. No.: US 2021/0140596 A1
(43) Pub. Date: May 13, 2021

(54) LIGHT FIXTURE WITH CLUSTERED LED DISTRIBUTION

(71) Applicant: Lighting Solutions Group LLC, Columbus, OH (US)

(72) Inventors: Gerald Lauck, Columbus, OH (US); Ricky Nathans, Columbus, OH (US)

(21) Appl. No.: 17/091,028

(22) Filed: Nov. 6, 2020

Related U.S. Application Data
(60) Provisional application No. 62/932,669, filed on Nov. 8, 2019.

(51) Int. Cl. F21S 4/28; F21V 23/00; A01G 9/24

(52) U.S. Cl. CPC F21S 4/28; F21Y 2115/10; A01G 9/249; F21V 23/005

(57) ABSTRACT

A light fixture for horticultural applications is provided wherein the fixture has a predetermined patent and nonuniform distribution of LEDs. The nonuniform distribution of LEDs forms at least one light cluster that is strategically positioned on the light fixture to greatly reduce or even eliminate light drop off that might otherwise be experienced by plants that are positioned adjacent to the light fixture in the growing environment.

### CROSS-REFERENCE TO RELATED APPLICATION

This application claims the benefit of U.S. Provisional Application No. 62/932,669, filed Nov. 8, 2019, the disclosure of which is hereby incorporated by reference as if fully restated herein.

### FIELD OF THE INVENTION

The present invention relates to light fixtures. More particularly, this invention concerns light fixtures comprising light emitting diodes (“LEDs”) that are distributed upon and preferably affixed to a circuit board such that at least two regions of LEDs are formed upon the circuit board wherein one of the LED regions comprises a cluster of LEDs.

### BACKGROUND AND SUMMARY OF THE INVENTION

Light fixtures comprising LEDs are generally positioned a significant distance away from the surface intended to be hit by the light. The current device is a LED light that is primarily used in horticultural systems. While LED lights have been used for horticultural lighting in the past, the known LED lights and lighting systems have generally uniform LED distributions. The current device, uses nonuniform LED distributions, and in preferred embodiments uses at least one cluster of LEDs providing a higher concentration of LEDs in at least one region of the light fixture. For example, one preferred light fixture of the present invention comprises a circuit board having a generally rectangular shape, a first plurality of LEDs distributed along the length of the circuit board in a row such that the row of LEDs spans nearly the entire length of the circuit board, a second plurality of LEDs that is distributed in a row adjacent to a portion of the first plurality of LEDs but which spans a shorter distance of the length of the circuit board, and a third plurality of LEDs that is distributed in a row adjacent to a portion of the first plurality of LEDs but which spans a shorter distance of the length of the circuit board such that the second and third row are disposed about a part of the first row of LEDs forming a cluster of LEDs in a region of the Fixture. Within that region, the concentration of LEDs upon the circuit board per unit area of its surface is greater than in the region of the circuit board which spans most of its length (i.e. the area of the circuit board that does not include any of the second plurality or third plurality of LEDs). In preferred embodiments, a light fixture comprises a generally rectangular circuit board having a length that is substantially greater than its width, a first end, and a second end opposite the first end, wherein there are clusters of LEDs near both ends of the length of the circuit board.

Light drop off is an unfortunate side-effect of many known light fixtures. More specifically, objects sitting near certain portions of known light fixtures may receive less light than objects sitting near other portions of the light. This is referred to as light drop off and can limit the growth and/or productivity of plants when the lights in question are being used for horticultural lighting. Exemplary light fixtures of the present invention comprise one or more clusters of LEDs that can be strategically positioned on the fixtures and within horticultural lighting systems to prevent light drop off that might otherwise be experienced when LED light fixtures are used in close proximity to plants in horticultural settings. The configuration and utilization of the current device are not and have not been contemplated by the prior art.

In addition to the novel features and advantages mentioned above, other benefits will be readily apparent from the following descriptions of the drawings and exemplary embodiments.

Horticulture lighting is known in the art. US Pub. No, 2010031562, for instance, describes a lighting installation for use in greenhouse farming for lighting crops in a greenhouse, comprising a number of light sources, such as lamps, provided above the crops to be lighted, and a number of dimmer devices for the light sources, characterized in that the dimmer devices are provided with control means for periodically, automatically varying the light intensity of the light sources cooperating with the dimmer devices according to a predetermined pattern.

US Pub. No. 2010031562 aims to provide a method and lighting installation, respectively, for greenhouse farming. In particular, the light sources are divided into a number of groups, the lighting installation being designed such that, in use, the power of each group varies according to a predetermined pattern, while patterns of different groups are phase-shifted relative to each other such that the electric power consumed by the joint groups varies less than the sum of the power variations of the separate groups, more particularly such that the electric power consumed by the joint groups varies less than the power variation of a single group, more particularly still such that the electric power consumed by the joint groups varies to a smallest possible extent, or does, at least virtually, not vary. In particular, all patterns are the same, but only phase-shifted relative to each other.

U.S. Pub. No. 20200232613, the disclosure of which is specifically incorporated herein by reference in its entirety, teaches a modular LED lighting system that solves several problems with other prior art LED systems, but does not address the same problems as nor does it teach the light fixtures having at least one cluster of LEDs taught herein.

Various manufacturers make LED lighting systems for horticultural use. However, none of the commercially available or known systems disclose a system as herein taught in which clusters of LEDs distributed in key areas of the light fixtures drastically reduce—and potentially eliminate—light drop off.

### BRIEF DESCRIPTION OF THE DRAWINGS

FIG. 1 shows a bottom view of a first exemplary embodiment of a light fixture of the present invention wherein the exemplary fixture comprises four clusters of LEDS;

FIG. 2 shows a close-up view of an LED cluster of the exemplary light fixture of FIG. 1;

FIG. 3 shows a bottom view of a second exemplary embodiment of a light fixture of the present invention wherein the fixture as shown comprises two clusters of LEDs;

FIG. 4 shows a close-up view of an LED cluster of the exemplary light fixture of FIG. 3;

FIG. 5 shows a bottom view of a third exemplary embodiment of a light fixture of the present invention; and

FIG. 6 provides an example of how light drop-off can be eliminated using light fixtures of the present invention wherein FIG. 6A illustrates light reaching a plant canopy using the exemplary light fixture shown in FIG. 1 and eliminating light drop-off and FIG. 6B shows light reaching a canopy using a light fixture that does not practice the present invention such that a number of plants positioned adjacent to the light fixture will be affected by light drop off.

### DETAILED DESCRIPTION OF EXEMPLARY EMBODIMENT(S)

The light fixtures disclosed herein are for use in the horticultural industry or a horticultural facility.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain some of the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

Preferred embodiments of the present invention, such as the exemplary embodiment shown in FIG. 1, include at least one light fixture 100 comprising a circuit board 110 having a generally rectangular shape, a first row of LEDs 210 distributed along the length of the circuit board 110 in a row such that the first row of LEDs 210 spans nearly the entire length of the circuit board 110, a second row of LEDs 220 that is distributed in a row adjacent to a portion of the first row of LEDs 210 but which spans a shorter distance of the length of the circuit board 110 and a third row of LEDs 230 that is distributed in a row adjacent to a portion of the first plurality of LEDs 210 but which spans a shorter distance of the length of the circuit board 110 such that the second 220 and third row 230 are disposed about a part of the first row of LEDs 200 forming a cluster 300 of LEDs in at least one region of the Fixture. FIG. 2 shows a close-up of an exemplary LED cluster 300 of the Exemplary Fixture shown in FIG. 1.

In the exemplary embodiment shown in FIG. 1, the light fixture comprises four light bars wherein each bar comprises a cluster of LEDs. As can be seen, each of the exemplary light bars comprises a non-uniform distribution of LEDs upon a circuit board such that the LEDs can generally be classified as forming a first region of LEDs and a second Region of LEDs. The second region of LEDs in this exemplary embodiment, spans most of the length of the light bar while the first region of LEDs spans a short length of the light bar near one of its ends. The first region of LEDs has a higher concentration of LEDs per unit area than the second region. The first region of LEDs comprises an LED cluster 300.

Though the exemplary embodiment of a light fixture 100 shown in FIGS. 1 and 2 forms a cluster of LEDs using just three strategically placed rows of LEDs, in some embodiments, additional rows of LEDs may be utilized to form an LED cluster. Moreover, while the light fixture 100 utilizes a second row 220 and third row 230 of LED's that comprise the same number of LEDs which are positioned symmetrically about the first row of LEDs 210, in some embodiments, the second row 220 and third row 230 may comprise different numbers of LEDs and may not be symmetrical about the first row 210.

The exemplary light Fixture shown in FIG. 1 comprises four light bars 400 wherein each light bar 400 is generally rectangular in shape and comprises a circuit board 110, LEDs (210, 220, and 230) connected to the circuit board 110, a heat sink (not shown) connected to the opposite side of the circuit board 110 from the side on which the LEDs are placed, and an electrical connection (not shown) which supplies electricity to the LEDs wherein all of the foregoing are contained in a housing 500. A lens may be positioned on the housing 500 to substantially cover the LEDs but which would permit for the passage of light. As shown in FIG. 1, the Exemplary light fixture comprises four LED clusters 300 wherein there is an LED cluster 300 on one end of each of the light bars 400. In another exemplary embodiment, the fixture shown in FIG. 1 could include more or less LED clusters. For example, in one additional embodiment, the light fixture could comprise eight LED clusters such that each light bar 400 would have two LED clusters 300: one on each end of the length of the light bar.

In some exemplary embodiments, such as those shown in FIGS. 1 through 4, a light fixture comprises a circuit board and a plurality of light emitting diodes connected to the circuit board in a predetermined pattern wherein the predetermined pattern forms at least two regions of light emitting diodes upon the circuit board wherein the regions have nonuniform distributions of LEDs in comparison to each other and one of the regions (the first region) has a higher concentration of light emitting diodes per unit area than the second region such that the first region contains an LED cluster. The shape and positioning of the LED cluster can vary depending on the needs of the horticultural lighting application for which the light will be used.

In some exemplary embodiments, LED clusters may only be positioned at the ends of at least one generally rectangular light bar 400 of a light fixture 100. In other exemplary embodiments, LED clusters 300 may be positioned at the ends and along the length (either spaced equidistantly or sporadically along the length) of at least one generally rectangular light bar 400 of a light fixture 100. In some embodiments, such as those shown in FIGS. 1 through 4, the LED clusters are fixed upon a circuit board such that they cannot generally be repositioned without repositioning of the entire light fixture of which they are apart. In some exemplary embodiments, an LED light cluster, may not span the width of the generally rectangular circuit board on which it is disposed.

Exemplary embodiments of light fixtures of the present invention comprise at least one electrical connection to electrically connect the plurality of light emitting devices disposed upon the fixture to a power supply. It will be appreciated by one of ordinary skill in the art upon reading the present application that there are a variety of ways one or more power supplies can be configured to supply power to the invention disclosed herein. In some embodiments, at least some of the LED cluster(s) of a light fixture are connected to a separate power supply than non-clustered LEDs.

FIG. 3 shows a second exemplary light fixture 1000 of the present invention. The exemplary light fixture 1000 comprises a light bar 4000 that is generally rectangular in shape having a length and a width wherein the light bar 4000 comprises a circuit board 1110 and at least one LED cluster 3000. As shown in FIG. 4, the LED cluster 3000 of the FIG. 3 embodiment may be formed by positioning LEDs in closer proximity to each other and at a higher concentration than LEDs in other regions of the light bar 4000. As shown in FIGS. 3 and 4, if a light bar 4000 has rows 5000 of LEDs positioned equidistantly along most of its length wherein each of the equidistant rows of LEDs 5000 has a substantially similar concentration and layout of LEDs, a cluster 3000 may be formed in a region of the light bar 4000 by placing more rows of LEDs 6000 in that region that may contain more LEDs than the equidistant rows 5000 and positioning the rows 6000 closer together than the equidistant rows 5000 positioned along most of the length of the light bar 4000.

Although the exemplary fixture 1000 shown in FIG. 3 only includes a single light bar 4000, it should be appreciated by one of ordinary skill in the art upon reading the present disclosure that a fixture of the present invention could include more than one light bar 4000 in some exemplary embodiments wherein at least one of the light bars 4000 comprises at least one LED cluster 3000. FIG. 5 for example, shows an exemplary light fixture 6001 comprising more than one light bar 6400 wherein each light bar 6400 is generally rectangular in shape and comprises two LED clusters 6300: one at each end of the length of the light bar 6400, Each light bar 6400 comprises a housing 6500 with a circuit board 6100 upon which all of the LEDs are affixed (including the clustered 6300 and un-clustered 6210 LEDs). In some exemplary embodiments, the housings 6500 may be one large integral housing that creates numerous light bars 6400 or they may be distinct housings 6500 that are connected to each other by one or more support members 6600.

One exemplary light fixture of the present invention comprises a circuit board with a plurality of LEDs positioned thereon such that the LEDs form at least two distinct regions wherein one region is an LED cluster having a higher concentration of LEDs per unit of area than at least one other LED region. There may be more than one LED cluster on the circuit board. In some exemplary embodiments, the LED clusters on the circuit board may each be generally the same shape and size, while in other exemplary embodiments the shape and size of the clusters may vary from cluster to cluster. In the exemplary embodiments shown in FIGS. 1 through 4, the light fixture and circuit boards are generally rectangular in shape. However, in other exemplary embodiments, a light fixture of the present invention may take other shapes (i.e. circular, square) to accommodate a given horticultural application. Moreover, multiple light fixtures of the present invention may be utilized in concert to provide lighting for an entire horticultural system or substantial part thereof.

In some exemplary embodiments, a modular LED system, such as that discussed in U.S. Pub. No. 20200232613 may incorporate LED clusters as taught by the present invention. So, an exemplary embodiment of a lighting system of the present invention may comprise a modular light for horticulture application comprising a plurality of LED lighting units wherein each lighting unit comprises one or more power wires for receiving power from a power source, a heat sink, a circuit board removably affixed to the heat sink wherein the circuit board comprises a plurality of LEDs that are wired to receive power from the power wires, a means for selectively receiving the power wires wherein the power wire receiving means is affixed to the circuit board such that the circuit board can be connected and disconnected from the power wires and the heat sink for easy replacement, and wherein the plurality of LEDs are distributed upon the circuit board creating at least two regions wherein one of those regions comprises an LED cluster having a higher concentration of LEDs than another region. The power wire receiving means may be an electrical connector. A preferred exemplary embodiment of a modular light comprises four lighting units wherein at least one of the lighting units comprises an LED cluster.

The shape and size of LED clusters utilized by the present application may be varied. In the exemplary LED cluster 300 shown in FIG. 2, the LED cluster 300 has a height H and a length X illustrated by arrows in the figure. Depending on the intended application, the length X of the LED cluster and/or height H of the LED cluster can be varied for example to provide maximum resistance to and/or substantial elimination of lighting drop off. In the exemplary LED cluster 3000 shown in FIG. 4, the LED cluster 3000 has a height H(1) and width X(1) as illustrated with arrows in the figure.

In one exemplary embodiment of the present invention, an exemplary light fixture comprises a circuit board comprising a first region of LEDs and a second region of LEDs affixed thereto. The first region of LEDs has a higher concentration of LEDs per unit area than the second region of LEDs and can be considered to be comprising an LED cluster. In this exemplary embodiment, a different type of LED is utilized within the first region of LEDs than that which is utilized in the second region of LEDs. A first region of LEDs may comprise LEDs with a higher light output than the LEDs utilized in the second region of LEDs. This may assist in reducing or eliminating lighting drop off.

In one exemplary embodiment of the present invention, a system of horticultural lighting comprises a first generally rectangular light fixture positioned adjacent to a second generally rectangular light fixture such that the first light fixture and second fixture are aligned linearly over a canopy of plants. The first light fixture comprises a housing adapted to receive a circuit board and which has received a circuit board, a heat sink in contact with the circuit board and wherein the circuit board comprises a first region, a second region, and a third region of LEDs affixed thereto. The first region and third region of LEDs each have a higher concentration of LEDs per unit area than the second region of LEDs. The first region and third region of LEDs comprise clusters of LEDs and are preferably positioned on the circuit board such that the first region is at or near a first end of the light fixture's length and the third region is at or near the opposite end of the light fixture. The second light fixture of this exemplary embodiment comprises a housing adapted to receive a circuit board and which has received a circuit board, and a heat sink in contact with the circuit board and wherein the circuit board has a first region and a second region of LEDs affixed thereto. The second region of LEDs has a higher concentration of LEDs per unit area than the first region of LEDs and comprises a cluster of LEDs. The second region of LEDs is preferably positioned at or near the end of the second light fixture which is farthest away from the first light fixture. By not including a cluster of LEDs on the second light fixture at the end which is nearest the first light fixture, energy and cost savings may be experienced because the clusters of LEDs are spaced out as opposed to positioned next to each other. In some exemplary embodiments, a third generally rectangular light fixture may be positioned next to the second light fixture. The third generally rectangular light fixture may be substantially identical to the second light fixture and positioned such that the cluster of LEDs on the third fixture is positioned at or near the end of the third light fixture which is farthest away from the second light fixture.

In a preferred method of using a light fixture of the present invention, at least one light fixture is disposed at a distance of between 3 and 12 inches from at least one plant that is to be grown using light obtained from the fixture. The light fixture may be generally rectangular in shape having a length and width such that the width is shorter than the length and comprising a circuit board wherein a first region of LEDs and a second region of LEDs are affixed to the circuit board. The first region of LEDs has a concentration of LEDs per unit area that is greater than the second region such that the first region comprises a cluster of LEDs. The first region is preferably positioned at or near a first end of the length of the fixture, Plants are ideally positioned along the entire length of the light fixture such that the plants obtain light from the fixture. At least some portion of the canopy of the plants may extend past the length and/or width of the light fixture. When power is supplied to the LEDs of the light fixture, the LED cluster puts off additional light such that the at least some portion of the plant canopy which extends past the length and/or width of the light fixture obtains nearly the same amount of light as the plant canopy positioned directly under the light fixture. Accordingly, the plants do not experience substantial light drop off.

Some exemplary embodiments comprise a method of using at least one cluster of light emitting diodes fixed upon a circuit board of a lighting fixture to optimize plant growth within an indoor horticultural facility. For example, a light fixture such as one of the exemplary fixtures shown in FIGS. 1 through 5 may be placed in relatively close proximity to a plurality of plants that are being grown in a horticultural facility. The plurality of plants and the lighting fixture may be positioned such that the fixture is positioned over some but is not able to be positioned over all portions of the plants (i.e. at least some of the plant canopy extends out from underneath the light fixture). The examples shown in FIG. 6, illustrate how two different light fixtures—one of which is a light fixture of the present invention—may be positioned over plants being grown in a horticultural facility and how their light output may differ. The dashed lines in FIG. 6 illustrate plants positioned under the fixtures. The darker shading shown in the figures, is used to illustrate light that is of substantial enough saturation that it is likely to promote healthy plant growth. Because the exemplary light fixture shown in FIG. 6A comprises at least one LED cluster, light drop-off is eliminated and substantial portions of the plants that are not under the fixture still receive an amount of light that is likely to enable them to grow successfully. As can be seen, the exemplary light fixture shown in FIG. 6A comprises four light bars generally rectangular in shape and each of which comprises an LED cluster at one end. The LED light cluster(s) of the light fixture minimize light drop-off that would otherwise be experienced by and detrimental to plants that are not positioned under/completely under the light fixture. In contrast, the light fixture shown in FIG. 6B does not comprise LED clusters and as can be seen, does not supply sufficient light to as much area of plants positioned under the light and portions of the plant canopy which extend out from underneath the light fixture will not obtain sufficient light to promote healthy plant growth.

What is claimed is:

1. A lighting fixture for use in a horticultural facility comprising:
a circuit board;
a plurality of light emitting diodes disposed upon the circuit board in a predetermined pattern such that the distribution of the plurality of light emitting diodes upon the circuit board is nonuniform and forms at least one cluster of light emitting diodes; and
at least one electrical connection to electrically connect the plurality of light emitting diodes to one or more power supply.

2. The lighting fixture of claim 1 wherein the circuit board is generally rectangular in shape having a length that is greater than its width.

3. The lighting fixture of claim 2 wherein there is only one cluster of LEDs disposed upon the circuit board and it is positioned near an end of the length of the circuit board.

4. The lighting fixture of claim 2 wherein there are two LED clusters affixed to the circuit board such that one is affixed to the circuit board at a first end of its length and the second cluster is affixed to the circuit board at the opposite end of its length.

5. The lighting fixture of claim 1 wherein the at least one cluster of light emitting diodes is positioned upon the circuit board such that it is adapted to prevent light drop-off experienced by plants within the horticultural facility.

6. A lighting fixture for use in a horticultural facility comprising:
a housing;
a first circuit board contained within said housing;
a plurality of light emitting diodes disposed upon the first circuit board in a predetermined pattern such that the distribution of the plurality of light emitting diodes upon the circuit board is nonuniform and forms at least one cluster of light emitting diodes;
a second circuit board contained within said housing;
a plurality of light emitting diodes disposed upon the second circuit board in a predetermined pattern such that the distribution of the plurality of light emitting diodes upon the circuit board is nonuniform and forms at least one cluster of light emitting diodes; and
at least one electrical connection to electrically connect the plurality of light emitting devices disposed upon the first and second circuit boards to one or more power supply.

7. The lighting fixture of claim 6 wherein the first and second circuit boards are generally rectangular in shape having a length that is greater than its width.

8. The lighting fixture of claim 7 wherein there is only one LED cluster disposed upon the first circuit board and only one LED cluster disposed upon the second circuit board and both clusters are positioned near the end of the length of the circuit board on which they are disposed.

9. The lighting fixture of claim 7 wherein there are two LED clusters disposed upon each of the first and second circuit boards.

10. The lighting fixture of claim 6 wherein the at least one cluster of light emitting diodes of the first and second circuit boards is positioned upon each of the circuit boards such that it is adapted to prevent light drop-off experienced by plants within the horticultural facility.

11. A lighting fixture for use in a horticultural facility comprising:
a housing;
a generally rectangular circuit board having a length and a width wherein the length is greater than the width and said circuit board is disposed within said housing; and
a plurality of light emitting diodes disposed upon the circuit board in a predetermined pattern such that the distribution of the plurality of light emitting diodes upon the circuit board is nonuniform and forms at least one cluster of light emitting diodes towards an end of the length of the circuit board.

12. The lighting fixture of claim 11 wherein there is a second LED cluster positioned near the opposite end of the length of the circuit board from the position of the first LED cluster.

13. The lighting fixture of claim 11 wherein the cluster of light emitting diodes is positioned upon the circuit board such that it is adapted to prevent light drop-off experienced by plants within the horticultural facility.

14. The lighting fixture of claim 11 wherein the generally rectangular circuit board and housing from at least one light bar.

15. The lighting fixture of claim 14 further comprising multiple light bars that are connected to one another by at least one support member.

16. The lighting fixture of claim 15 wherein each of the light bars is generally rectangular in shape.
